(19) United States
(12) Patent Application Publication
(10) Pub. No.: US 2025/0353049 A1
(43) Pub. Date: Nov. 20, 2025

(54) Garbage Chute Crawler Cleaning Robot

(71) Applicant: Nimrod Epelshtein, Pismo Beach, CA (US)

(72) Inventor: Nimrod Epelshtein, Pismo Beach, CA (US)

(21) Appl. No.: 18/663,382

(22) Filed: May 14, 2024

(51) Int. Cl. B08B 9/045; A46B 9/02; A46B 13/00; A46B 13/02; A46B 15/00; A46D 1/00; B08B 13/00; B65F 7/00; B65G 11/02; B65G 45/18; B65G 45/22

(52) U.S. Cl. CPC B08B 9/045; A46B 9/026; A46B 13/001; A46B 13/02; A46B 15/0004; A46D 1/0207; B08B 13/00; B65F 7/00; B65G 45/18; B65G 45/22; A46B 2200/3013; B08B 2209/04; B65G 11/026

(57) ABSTRACT

The present invention provides the buildings with a stationary built-in and an automatic unmanned intelligent robotic cleaning device embodied for physically cleaning the garbage chute and removing all waste sediments effectively including small to medium blockages arising in the building garbage chute through a sequence of programmed steps comprising the methodology.

### FIELD OF THE INVENTION

The field of invention relates to a steel vertical garbage and laundry chute cleaning device. More specifically, the said device utilizes automatic and intelligent mechanism effectuated through remote settings in its control for better cleaning of a garbage chute and removing the waste sediments effectively in frequent intervals without interrupting residents routine, at a minimized cost and unmanned.

### BACKGROUND OF THE INVENTION

A trash chute is a great solution for collecting garbage in buildings, but it can also cause problems from the waste sediments, such as bad odor, bacteria, fungi and more. These issues impact the residents of the building. At the present there is one main solution which is removing some of the waste sediments and odor from the chute with a rotating nozzle that sprays hot water on the chute walls. It is connected to a hot water and pressure generator powered by diesel or electricity. It's an outsource service operated by a team of 2 persons. This service is provided to buildings at a high cost and blocking the chute for users for a few hours during day time. That is why most buildings are using it only a few times a year.

Various utility patents dealing with vertical cleaning devices are in vogue. CA2611956A1 titled “Garbage chute cleaning machine” is a mix of ideas and the latest technological products on the global market. This is a device (machine) that has the purpose of cleaning the pipes inside and especially the columns garbage dump (waste chute). The problem for all the countries of the world is the hygiene of the our environment. This machine will solve all the problems of cleaning and disinfection of the waste chute. We know that in a waste chute, because of all the products that slide in, we have a layer of grease and results of organic waste (food products) and inorganic (mineral oil, paint, chemical substances) which will help to develop bacteria that can come into contact with us by our hands or by our breathing. Waste scraps are provided with a washing system but it gives nothing without a washing with hot water and a good brushing. The general problem of having an interior brush is a technical problem, so it is difficult to print a local rotational movement for the brush or the entire anchoring system. For this reason I chose the best technical products that give me very good results. Descriptions: 1. Pneumatic cylinder (it can be chosen and electric) which will print for the brush a vertical up and down movement in a continuum way. This jack is located at the top of the waste chute (on the roof) provided with an adjustable height support. 2. Pneumatic or electric cylinder which will print for the brush a movement of rotation which is in brush. 3. brush: it can be a brush roll of a certain length (longer is better) or disc brushes located on a vertical axis at a distance from one another. 4. A pressure water heater that will water with pressure the inside of the chute to dissolve the grease (this is done at the level of the brush hair by a long hose that rises from bottom to top) and which uses a biodegradable germicide 5. a range of valves, regulators, rods, timers, motion sensors, electric winch, compressor, filter regulator. Thus the brush will have a vertical and horizontal reciprocating movement and a right-left reciprocating movement for a desired angle and at the same time a pressure wash with hot water and germicidal product.

Another application CN111359813A titled “Be used for anticorrosive spraying device of chimney inner wall and an inner wall gallows” discloses an anti-corrosion spraying device for an inner wall of a chimney and a support hanger on the inner wall, which solves the problems that the coating of anti-corrosion materials on the inner wall of the chimney and a support hanger structure on the inner wall mainly depends on manpower, the efficiency is low, and the potential safety hazard is high. The lifting of the whole device in the chimney is completed through the winch, the paint spraying assembly is used for spraying anticorrosive paint on the inner wall of the chimney, the whole process does not need to manually enter the chimney, the potential safety hazard is greatly reduced, and the working efficiency is improved. The spraying component is driven by the driving component to move, and the distances between the spray gun A and the spray gun B and the inner wall of the chimney and between the spray gun A and the spray gun B and a support hanger on the inner wall are adjusted, so that the spraying component can be suitable for chimneys with different diameters, and the application range of the spraying component is expanded; the coating on the inner wall of the chimney and the support hanger on the inner wall is quickly and uniformly heated and dried by the drying component. The inner wall of the chimney is uniformly cleaned through the rotation of the main scraping piece along with the main shaft; the cleaning range of the inner wall of the chimney is expanded through the auxiliary scraping piece, and preparation is made for the cleaning work of the main scraping piece.

Application no. US20120090111A1 titled “Working device for an internal pipe and working method for the same” discusses about a method and a device for performing work in pipelines, whereby it is possible to exert an extremely large driving force within a pipeline. Moreover, provided are a method and a device for performing work in pipelines, which are provided with a means for forcibly drying the wet inner surface of a pipeline. The device is provided with an annular pressure boundary seal with a free-end portion that comes into contact with the inner wall of the pipeline. The seal separates the space within the pipeline into two spaces, a space (A) and a space (B), using the seal as a boundary. The end of the space (A) adjacent to the seal is connected with a suction pump via a hose, while the other end of the space (A), which is not adjacent to the seal, is connected with the fluid surrounding the pipeline via a vacuum breaker that adjusts the negative pressure within the space (A). A hose is disposed in the space (B) and the end of the space (B), which is not adjacent to the seal, is connected with the fluid that surrounds the pipeline.

However, none of the stated prior arts have remote and autonomous mechanism for cleaning of garbage chute as is the prime focus of the present invention.

### SUMMARY OF THE INVENTION

An aspect of the invention is to provide an improved automatic device for cleaning and maintaining the garbage chute of buildings.

Another aspect of the invention is to provide the buildings with a stationary built-in along with an automatic device embodied for physically cleaning the garbage chute and removing all waste sediments effectively.

A still further aspect of the invention is to provide an automated device which may clean the garbage chute at a low cost, high frequency and in a highly effective manner.

Another aspect of the present invention is to provide an automated device which aids in cleaning of the garbage chute without the requirement of an external company being called for regular services.

A still further aspect of the invention is to provide an automated device for cleaning of buildings garbage chutes, wherein the chutes may be cleaned at a suitable time which does not disrupt the normal schedule of the residents of the building.

A further aspect of the invention is to provide an automated device which is capable of removing small to medium blockages arising in the building garbage chute.

An object of the present invention is to clean the garbage chute of a building, and to control the cleaning device of the building by remotely setting and controlling the cleaning device.

Another object of the invention is the use of a specially designed unmanned and intelligent robotic cleaning device.

Still further aspect of the invention involves the said robotic cleaning device cleaning the garbage chutes of buildings through a sequence of programmed steps comprising the methodology.

### BRIEF DESCRIPTION OF THE DRAWINGS

FIG. 1 is a perspective view depicting the garbage chute crawler with the lid and housing of the robotic crawler assembled with the unit.

FIG. 2 is a perspective view depicting the garbage chute crawler with the lid and housing of the robotic crawler dis-assembled from the unit.

FIG. 3 is a front perspective view depicting the garbage chute crawler with the lid of the robotic crawler assembled with the unit and the housing removed.

FIG. 4 is a perspective view from a different angle depicting the garbage chute crawler with the lid of the robotic crawler assembled with the unit and the housing removed.

FIG. 5 is a top perspective view depicting the garbage chute crawler with the lid and the housing of the robotic crawler assembled with the unit.

FIG. 6 represents an example of the garbage chute crawler cleaning robot of the present invention placed in the garbage chute for cleaning in buildings.

### REFERENCE NUMERALS

10 Garbage Chute 15 Motorized Cable Reel
25 External water source
35 Motor
30 Rollers
40 Battery Pack 45 Cylindrical Brush
50 Flexible Drive Shaft 55 Wheels
60 Housing 65 Top-Bottom Connector
70 Lid of the motor assembly 75 Eye Bolt
80 Stepper Drive 85 Motor Bench
90 Gears 95 PLC-COM
100 Garbage cleaning device

### DETAILED DESCRIPTION OF THE PREFERRED EMBODIMENTS

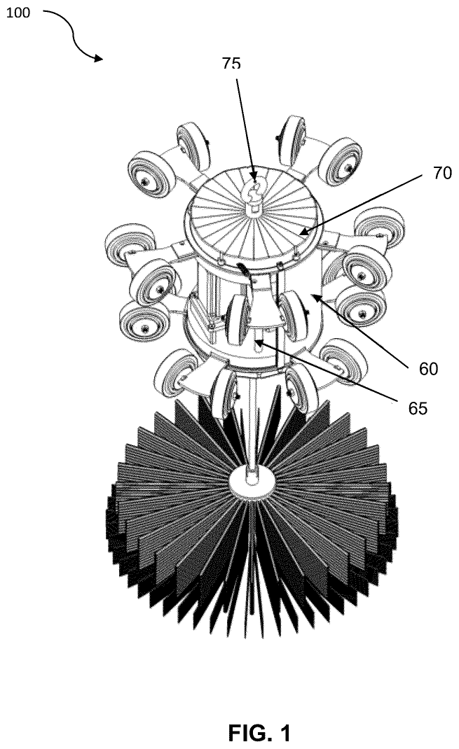

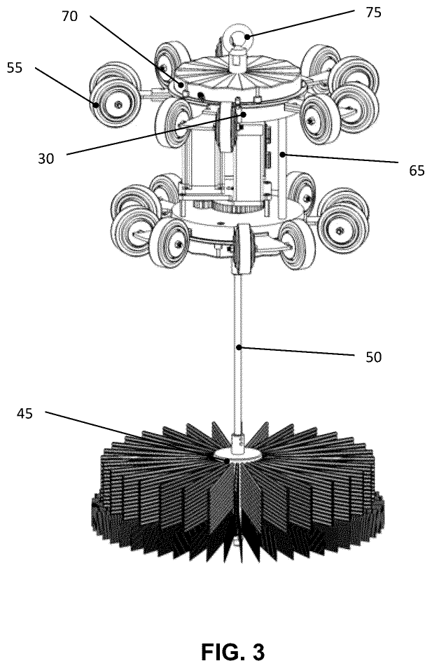

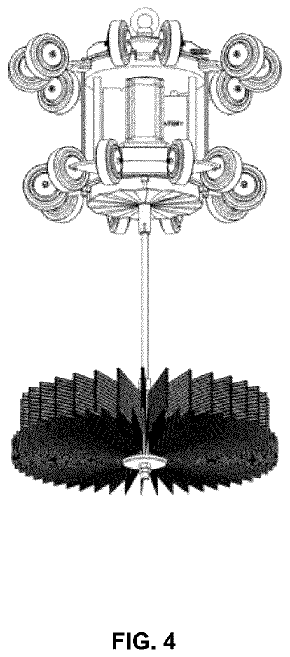

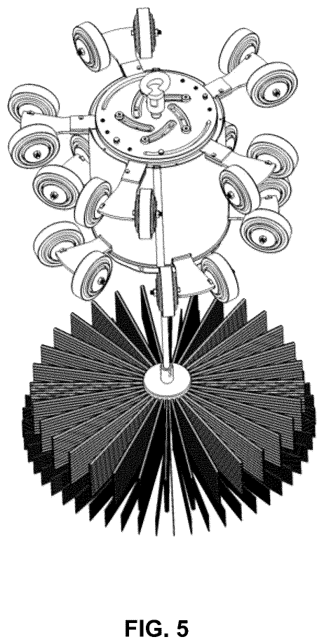

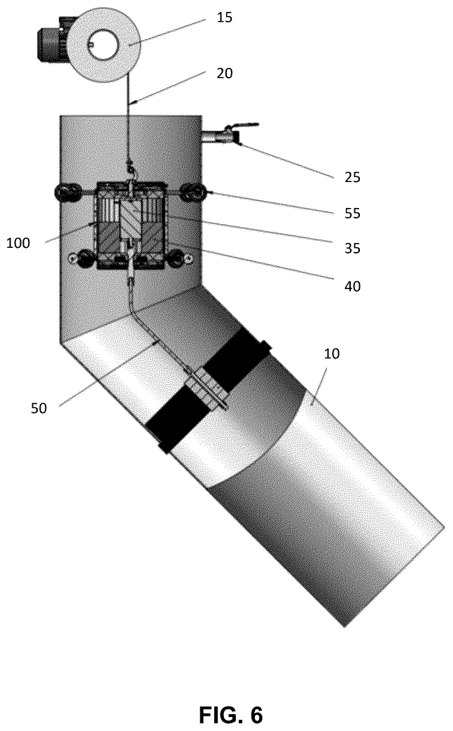

Below in conjunction with accompanying drawing, the present invention is further described: as shown in FIGS. 1-6, the specially designed unmanned robotic cleaning device—for garbage and laundry steel chute comprises the following:
A main housing of the robotic cleaning device (60);
Flexible drive shaft (50);
Cylindrical brush (45);
Motorized cable reel (15);
A pair of limit switches;
Rollers wheel assembly (30);
Motor (35);
Battery pack (40);
External water source with electrical valve (25);
External main controller and electrical panel;
Internal controller;
Roller spring mechanism;
Rotation sensor;
Cable tension sensor;
HMI monitor; and
Docking charging station.

The above components are now explained in conjunction with the deployed mechanism.

The robotic garbage chute cleaning device (100) as mentioned has a cylindrical housing (60) of aluminium having a lid (70). The lid (70) has an eye-bolt (75) which helps in connecting the motorized cable reel (15) with the robotic cleaner (100). The top and bottom of the said cylindrical housing (60) is each equipped with roller wheel assembly (30). The top and bottom of the cylindrical housing is connected by means of connector (65) which are four in number and positioned evenly. The device is further equipped with a rechargeable battery pack (40) comprising lithium ion batteries of 48v which powers the motor. The battery (40) is charged at the docked charging station, positioned at the top of the garbage chute connected to the electric panel when in stationary mode, upon a cleaning cycle being completed by the robotic cleaner. The cleaning robot (100) is provided with a plug which connects with the contact charging connecter of the docking charging station.

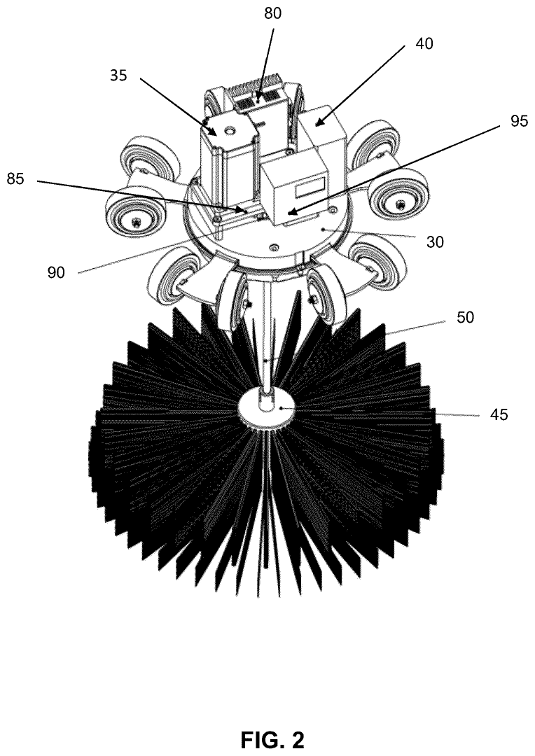

The robotic cleaner motor (35) is equipped with a geared stepper drive (80) installed inside the robotic body and is stationed on a motor bench (85) as depicted in FIG. 2. This motor functions to control the movement down-stop-up of the robotic cleaner in the steel vertical garbage chute by means of motorized cable reel (15), where the stepper drivers (80) convert pulse signals from the controller into motor motion to achieve precise positioning. The stepper driver converts a train of input pulses (typically square waves) into a precisely defined increment in the shaft's rotational position.

The robotic cleaner of the present invention is equipped with a motorized steel cable reel (15) connected at the top of the robot and operated by the motor (35) which releases the steel cable (15) upon receiving signal in the form of an electric pulse, from the controller allowing the robot to descend the garbage chute (10).

The cleaning of the garbage chute is accomplished by means of rollers operable by a spring mechanism, cylindrical brush (45) and a flexible drive shaft (50). The robotic cleaner is further provided with 10 roller (55) sets, 5 sets in the upper side of the robot and 5 sets on the bottom side. Each set has a pair of rollers made from TPR rubber and installed on an arm, connected to the main robotic body through a spring mechanism. When activated the spring mechanism pushes the rollers out towards the garbage chute tube walls and helps the robotic cleaner to crawl through the robotic chute.

Further equipped with the robotic cleaner (100) is the flexible drive shaft (50) connecting the motor with the cylindrical cleaning brush (45). The said brush comprises of a hard plastic brush core with nylon bristles filaments. When activated, the drive shaft (50) rotates the cleaning brush (45) which in-turn scrubs the inner wall of the garbage chute (10).

The garbage chute robotic cleaner (100) is also equipped with a rotation sensor positioned next to the motor (35) and connected with the controller device. On activation of the system, the rotation sensor analyses the status of the motor and the driving shaft and receives signals about the working conditions of the motor and the driving shaft. If the received signal is positive, it transmits the signal to the internal controller, which in-turn is communicated to the external main controller and is displayed accordingly on the HMI monitor. In case the signals received is negative, a similar signal is communicated to the internal and external controller which is displayed on the HMI monitor and the motor receives the signal to terminate the motor.

In some embodiments, the motorized steel cable is equipped with a cable tension sensor, which prevents the release of motorized cable further, in case of obstruction or when the robot is stuck. The cable tension sensor, reads the obstruction and sends signal to the main controller to stop the release/withdrawal of the steel cable.

The limit of the descent and the ascent of the steel cable is determined by a pair of limit switches equipped with the motorized steel cable and connected with the external main control. When the system is activated the robot descends and reaches the extreme bottom, by means of releasing the motorized cable and upon reaching the bottom, the bottom limit switch is activated which sends the signal to the controller to change the direction of the motorized cable reel, from releasing to pulling up. The upper limit switch is activated and switches of the system when the robot reaches the top of the garbage chute, thereby finishing the cleaning cycle.

The robotic garbage chute cleaner is further, equipped with an external water source (25) with an electric valve which opens and releases water and detergent for cleaning the garbage chute when the system is activated.

The robotic cleaner includes in its system a PLC-COM (95) which functions to detect the state of the input devices of the robotic cleaner (100) including valves, multiple sensors such as but not limited to rotation sensors, cable tension sensors and execute the program instructions based on the input and operate the output devices connected to the PLC based on input.

The working of the robotic garbage chute cleaner works by means of wireless mechanism comprising of:
An external main controller with an electrical panel;
An internal controller;
An HMI monitor; and
A mobile application.

The external main controller along with electrical communication panel is installed on the wall external to the garbage shaft and connected to the building electrical grid which provides power to the system and communicates with the system components including motorized cable reel, the docking station for battery charging, HMI monitor, communication panel, water valve. The communication panel of the external controller comprises a -STM32 Nucleo-64 board connected with the single chip radio transceiver -nRF24L01.

The internal controller is positioned within the cleaning robot comprising STM32 Nucleo-64 board connected with a single chip radio trans receiver nRF24L01 which receives command from the external controller for activation of the motor by means of wireless signal by means of the electrical communication panel.

The HMI monitor of the present system is installed on the wall external to the garbage shaft near the external main controller and is used to program the robotic activity including the activity duration, date and time, speed and movement and provides real time inputs from the sensors.

In some embodiments of the present invention, the operation of the robotic cleaner may also be activated by means of a mobile application installed in any hand held instrument.

The entire process of automated cleaning of the garbage chute by means of the robotic cleaner involves the following steps:
Activating the robot by means of phone application or timer;
The external and internal controllers upon activation sends signal to the motor for commencing the cleaning process;
Upon receiving the signal the roller spring mechanism of the robotic cleaner is activated which pushes the roller sets towards the garbage chute tube walls for grubbing the chute walls and stabilizing the robot;
The electric valve of the external water source also receives signal to open the valve for releasing the water and detergent within the garbage chute;
The rotation sensor is also activated which analyses the condition of the motor and the flexible drive shaft keeps the drive shaft rotating for cleaning of the garbage chute at different angles;
The robotic cleaner is lowered by means of the motorized cable reel which controls the ascent and descent of the robotic cleaner. Upon reaching its lower bottom limit the automated limit switch is activated which signals the external controller for changing the direction of the robotic cleaner from descent to ascent. Once the robotic cleaner reaches its maximum upper limit, the upper limit switch is activated which signals the external controller to stop the robotic cleaner.

As the programmed cleaning cycle gets completed, the robotic cleaner, returns to the docking charging station, where it is re-charged before commencing on the next cleaning cycle.

In step 6, once the robotic cleaner ascends or descends along the garbage chute, the cable tension sensor transmits signal of the tension force on the steel cable. In case of obstruction in the cable, a signal is transmitted to the transreceiver of the external controller to terminate the process.

Many other changes and modifications can be made without departing from the spirit and scope of the invention. It is to be understood that the invention is not to be limited to the specific embodiments, but only by the scope of the appended claims.

What is claimed is:

1. An intelligent unmanned robotic cleaning device for garbage and laundry chutes of buildings, the device comprising:
a main body;
a battery pack;
a motor;
a motorized cable reel;
a pair of limit switches;
rollers operated by roller spring mechanism;
at least one rotation sensor;
at least one cable tension sensor;
docking charging station;
external water source with electric valve;
flexible drive shaft;
cylindrical brush;
an internal controller;
an external main controller with an electrical panel;
an HMI monitor; and
a mobile application,
wherein,
the said rollers connected to the main robotic body, by means of arms, and operated by spring mechanism;
wherein,
the said motor is a geared stepper motor and functions to control the movement down-stop-up of the robotic cleaner;
wherein,
the said motor is controlled by the said internal controller, which receives commands from the external controller after analyzing the signals received by the said multiple sensors;
wherein,
the cleaning of the said garbage chute is accomplished by the said cylindrical cleaning brush connected to the said flexible drive shaft.

2. The intelligent unmanned robotic cleaning device for garbage and laundry chutes of claim 1, wherein, the said main body is of aluminium made and the said motor is charged at the said docking station when in stationary mode.

3. The intelligent unmanned robotic cleaning device for garbage and laundry chutes of claim 1, wherein the said HMI monitor displays the analyzed results of the status of the said rotation sensor, the flexible drive shaft, the time and duration of the cleaning cycle.

4. The intelligent unmanned robotic cleaning device of claim 1, wherein the said cable tension sensor prevents the release of motorized cable, when encountered with an obstacle in the garbage chute.

5. The intelligent unmanned robotic cleaning device for garbage and laundry chutes of claim 1, wherein the said pair of limit switches, functions to limit the maximum decent and ascent of the robotic cleaner.

6. The intelligent unmanned robotic cleaning device of claim 1, wherein the said robotic cleaner is equipped with 10 roller sets, 5 sets in the upper side of the robot and 5 sets on the bottom side.

7. The intelligent unmanned robotic cleaning device of claim 1, wherein the said rollers are of TPR rubber.

8. The intelligent unmanned robotic cleaning device of claim 1, wherein the said cleaning brush comprises of a hard plastic brush core with nylon bristles filaments.

9. A system of an intelligent unmanned robotic cleaning device for garbage and laundry chutes, comprising:
a main body;
a battery pack;
a motor;
a motorized cable reel;
a pair of limit switches;
rollers operated by roller spring mechanism;
at least one rotation sensor;
at least one cable tension sensor;
docking charging station;
external water source with electric valve;
flexible drive shaft;
cylindrical brush;
an internal controller;
an external controller main controller with an electrical panel;
an HMI monitor; and
a mobile application,
wherein, the said external controller is connected to the building electrical grid for receiving power for the entire system and the said system communicates with the system components;
wherein, the said internal controller of the said robotic system receives command from the said external main controller for activation of the motor by means of wireless signal by means of the said electrical communication panel;
wherein, the said HMI monitor, is a means for programming the robotic activity including the activity duration, date and time, speed and movement.

10. The system of claim 9, wherein, the said system components includes motorized cable reel, the docking station for battery charging, HMI monitor, communication panel and water valve.

11. The system of claim 9, wherein, the said HMI monitor, provides real time inputs from the sensors.

12. The system of claim 9, wherein, the sensors includes the said rotation sensor and the said cable tension sensor.

13. The system of claim 9, wherein, the system is activated by means of mobile application, installed in a hand held device.

14. A method of cleaning the garbage chutes of buildings, the method comprising the steps of:
Step 1: Activating the robot by means of phone application or timer;
Step 2: Activating the external and internal controllers and sending signal to the motor for commencing the cleaning process;
Step 3: receiving the signals by the roller spring mechanism of the robotic cleaner and activating it, thereby pushing the roller sets out towards the garbage chute tube walls for grubbing the chute walls and stabilizing the robot;
Step 4: Receiving the signal by the electric valve of the external water source for opening the valve for releasing the water and detergent within the garbage chute;
Step 5: activating the rotation sensor which analyses the condition of the motor and the flexible drive shaft, keeping the drive shaft rotating for cleaning of the garbage chute at different angles;
Step 6: lowering the robotic cleaner by means of the motorized cable reel which controls the ascent and descent of the robotic cleaner;
Step 7: return of the robotic cleaner at the docking charging station, on completing the programmed cleaning cycle being complete, and charging before commencing on the next cleaning cycle.

15. The method of cleaning the garbage chutes of buildings of claim 14, wherein, the lower bottom limit switch is activated upon reaching its lower bottom limit which signals the external controller for changing the direction of the robotic cleaner from descent to ascent, wherein, upon reaching its maximum upper limit, the upper limit switch is activated which signals the external controller to stop the robotic cleaner.

16. The method of cleaning the garbage chutes of high-rises of claim 14, wherein, in step 6, in case of obstruction in the cable, once the robotic cleaner ascends or descends the garbage chute, the cable tension sensor transmits signal of the tension force on the steel cable and, a signal is transmitted to the trans receiver of the external controller to terminate the process.
